(19) United States
(12) Patent Application Publication
(10) Pub. No.: US 2016/0136678 A1
(43) Pub. Date: May 19, 2016

(54) DUAL WEB CONVEYANCE

(71) Applicant: Uni-Pixel Displays, Inc, The Woodlands, TX (US)

(72) Inventor: Robert J. Petcavich, The Woodlands, TX (US)

(21) Appl. No.: 14/552,873

(22) Filed: Nov. 25, 2014

Related U.S. Application Data
(60) Provisional application No. 62/080,369, filed on Nov. 16, 2014.

(51) Int. Cl. B05C 3/132

(52) U.S. Cl. CPC B05C 3/132

(57) ABSTRACT

A dual web conveyance system includes a first unwind unit configured to unspool a first web from a first spool, a first rewind unit configured to spool the first web around a second spool, a second unwind unit configured to unspool a second web from a third spool, a second rewind unit configured to spool the second web around a fourth spool, and a control system. The control system includes a first drive control unit configured to control a first unspooling speed of the first unwind unit, a first tension control unit configured to control a first spooling tension of the first rewind unit, a second drive control unit configured to control a second unspooling speed of the second unwind unit, and a second tension control unit configured to control a second spooling tension of the second rewind unit.

### CROSS-REFERENCE TO RELATED APPLICATIONS

This application claims the benefit of, or priority to, U.S. Provisional Patent Application Ser. No. 62/080,369, filed on Nov. 16, 2014, which is hereby incorporated by reference in its entirety.

### BACKGROUND OF THE INVENTION

Electroless plating is an autocatalytic reaction that may be used to deposit a metal on the surface of catalytic portions that are part of, or are disposed on, a substrate. Electroless plating may be described as a redox reaction with both partial reactions, anodic and cathodic, occurring at the same electrode. The anodic partial reaction includes the oxidation of a reducing agent contained within an electroless plating solution to yield one or more electrons that are transferred to the metal and/or by-products. The cathodic partial reaction includes the reduction of free metal ions or metal complexes to a metal lattice. The overall reaction results in metal plating onto the surface of the catalytic portions that are part of, or are disposed on, the substrate and then onto the deposited metal.

Immersion plating is a displacement reaction where a second metal displaces a portion of a first metal that is part of, or is disposed on, a substrate. In the displacement reaction, cations of the second metal displace atoms of the first metal to form a second metal layer, mixed-phase layers, an intermetallic second metal-first metal interface layer on top of the first metal layer and cations of the first metal. In this way, the ions of the second metal react with the first metal and reduce the first metal thickness in a controlled process resulting in a multi-layer metal stackup.

Electroless plating, immersion plating, and other wet processes require the submersion of the substrate in a liquid bath for a predetermined amount of time to achieve a desired metallization. Electroless plating, immersion plating, and other wet processes are used in a wide range of metallization applications including, for example, the fabrication of metal mesh touch sensors.

### BRIEF SUMMARY OF THE INVENTION

According to one aspect of one or more embodiments of the present invention, a dual web conveyance system includes a first unwind unit configured to unspool a first web from a first spool, a first rewind unit configured to spool the first web around a second spool, a second unwind unit configured to unspool a second web from a third spool, a second rewind unit configured to spool the second web around a fourth spool, and a control system. The control system includes a first drive control unit configured to control a first unspooling speed of the first unwind unit, a first tension control unit configured to control a first spooling tension of the first rewind unit, a second drive control unit configured to control a second unspooling speed of the second unwind unit, and a second tension control unit configured to control a second spooling tension of the second rewind unit. The control system controls the first unspooling speed of the first unwind unit and the first spooling tension of the first rewind unit to convey the first web at a first predetermined speed and at a first predetermined tension. The control system controls the second unspooling speed of the second unwind unit and the second spooling tension of the second rewind unit to convey the second web at a second predetermined speed and at a second predetermined tension.

Other aspects of the present invention will be apparent from the following description and claims.

### BRIEF DESCRIPTION OF THE DRAWINGS

FIG. 1 shows a block diagram of a wet process system in accordance with one or more embodiments of the present invention.

FIG. 2 shows a block diagram of a conventional web conveyance system.

FIG. 3 shows a block diagram of a dual web conveyance system in accordance with one or more embodiments of the present invention.

FIG. 4 shows a top down view of an electroless plating system with dual web conveyance in accordance with one or more embodiments of the present invention.

FIG. 5 shows a perspective view of an electroless plating system with dual web conveyance in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

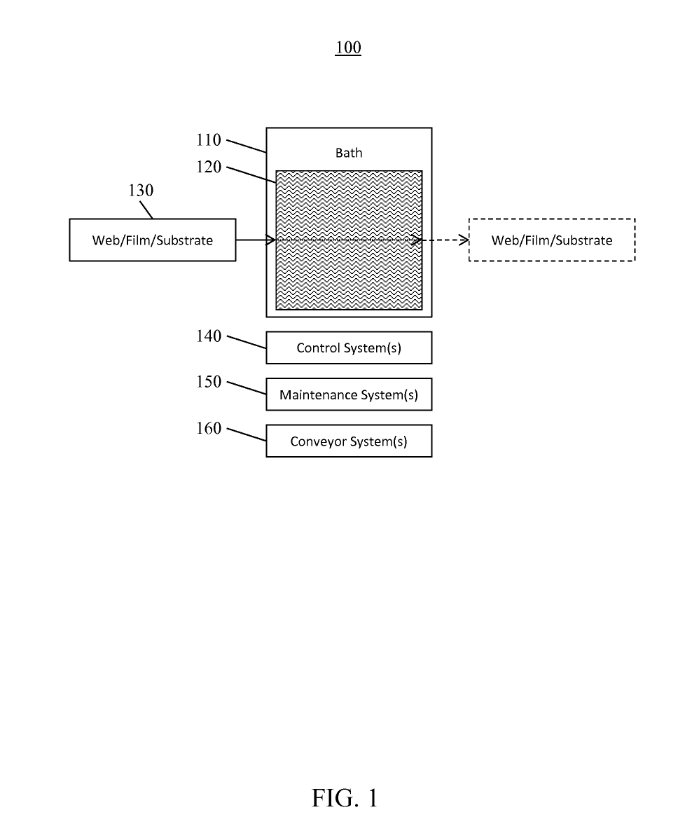

FIG. 1 shows a block diagram of a wet process system 100 in accordance with one or more embodiments of the present invention. The wet process system 100 may be an electroless plating system, an immersion plating system, or any other wet process system that includes the conveyance of a roll-to-roll web, film, or other flexible substrate material through a bath. For purposes of illustration only, an electroless plating system 100 shall be discussed in more detail herein. One of ordinary skill in the art will recognize that the same concepts may apply to other wet process systems in a similar manner in accordance with one or more embodiments of the present invention.

Electroless plating system 100 may include an electroless plating bath 110 in which a liquid electroless plating solution 120 may be disposed. A roll-to-roll web, film, or substrate material 130 may be conveyed through the electroless plating solution 120 to electrolessly plate catalytic portions (not shown) that are part of, or are disposed on, the web 130. The roll-to-roll web 130 may be composed of one or more of a semiconductor, glass, film, thermoplastic resin, thermosetting resin, polymer, ceramic, fabric, paper, composite material, or any other flexible substrate material suitable for use in electroless plating applications and capable of being conveyed in a roll-to-roll manner. Electroless plating system 100 may include one or more control systems 140, one or more maintenance systems 150, and one or more conveyor systems 160 that govern the operational and plating performance of the system 100.

When a portion of the roll-to-roll web 130 is submerged in the electroless plating solution 120, an autocatalytic reaction occurs that results in the deposition of metal (not shown) on the catalytic portions (not shown) that are part of, or are disposed on, the web 130 and then on the surface of the deposited metal itself. The catalytic portions comprise a material or substance that increases the rate of reaction without being consumed by the reaction. The deposition process continues until the catalytic portions are no longer in contact with electroless plating solution 120, any one or more of the reactants of the electroless plating solution 120 are depleted, there is excessive buildup of by-products (not shown), or the electroless plating bath 110 crashes or plates out. A desired thickness of metal may be deposited by controlling the amount of time that the web 130 is submerged in the electroless plating solution 120. Electroless plating system 100 may be used to electroless plate metals including, for example, copper, nickel, palladium, other platinum group metals, bismuth, gold, silver, cobalt, chromium, some composites, or alloys thereof.

Electroless plating solution 120 is inherently unstable and the chemistry tends to deteriorate over time. One measure of efficiency of an electroless plating system 100 is the up-time of the bath 110, sometimes referred to as the bath life. The bath life is the amount of time that a bath 110 is online and capable of effectively plating without undesirable plating characteristics. The bath life may be negatively impacted by control events that take the bath 110 outside normal operating conditions, maintenance events, or other failure modes including crashes or plate outs. As such, one goal of a production electroless plating system is maximization of the throughput of web material during operational bath life.

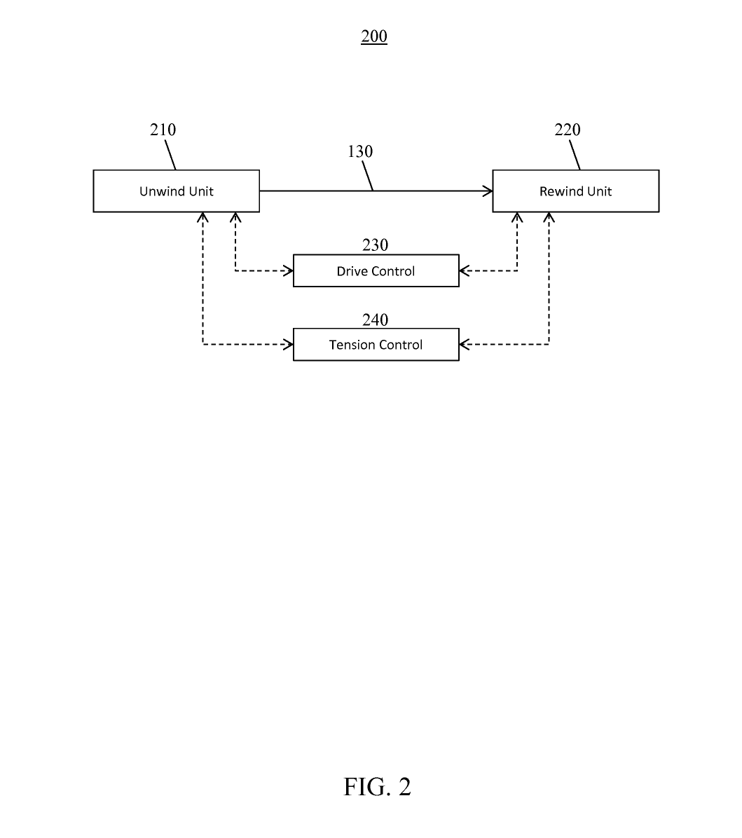

FIG. 2 shows a block diagram of a conventional web conveyance system 200. Web conveyance system 200 includes an unwind unit 210 and a rewind unit 220 that convey a roll-to-roll web 130 through a bath, such as an electroless plating bath, immersion plating bath, or other wet process bath (e.g., bath 110 of FIG. 1). The roll-to-roll web 130 is initially wound on a first removable spool (not shown) that is mounted to the unwind unit 210. The unwind unit 210 unwinds and feeds the web 130 that is conveyed through the bath and the rewind unit 220 receives and rewinds the web 130 as it exits the bath on a second removable spool (not shown) that is mounted to the rewind unit 220. A drive control system 230 may be used to control the speed at which the web 130 is conveyed and a tension control system 240 may be used to control the tension of the web 130 as it is being conveyed.

Wet process systems (e.g., wet process system 100 of FIG. 1) tend to be complicated systems comprised of interrelated electrical, mechanical, and chemical subsystems. To accommodate a wide variety of customer applications, manufacturers of wet process systems tend to offer systems that work in a variety of different applications, including the metal deposition of printed circuit boards. As such, commercially available baths tend to be wide, capable of accommodating submerged web 130 widths of, for example, up to 60 inches. However, some applications utilize web 130 of substantially narrower width leaving a substantial portion of the commercially available baths unused in a given application. For example, in certain touch sensor applications, a flexographic printing system may be used to flexographically print a catalytic ink image of a conductive pattern on a roll-t-roll polyethylene terephthalate (“PET”) web 130. The web 130 may have a width, for example, in a range between approximately 1 inch and approximately 20 inches. Subsequent to flexographic printing, the web 130 may be processed through an electroless plating system to deposit metal on the catalytic ink image of the conductive pattern, thereby forming a conductive pattern of the touch sensor. However, the web 130 is of a width that leaves a substantial portion of the commercially available bath unused. Because of the time constraints inherent in the electroless plating process, it tends to be the bottleneck in a production environment. If a given production run requires additional capacity, one or more additional electroless plating systems using conventional web conveyance may be required at substantial cost.

In one or more embodiments of the present invention, a dual web conveyance system increases the capacity and throughput of conventional wet process systems by making more efficient use of the available capacity within the existing commercially available baths while maintaining the quality of the chemical environment.

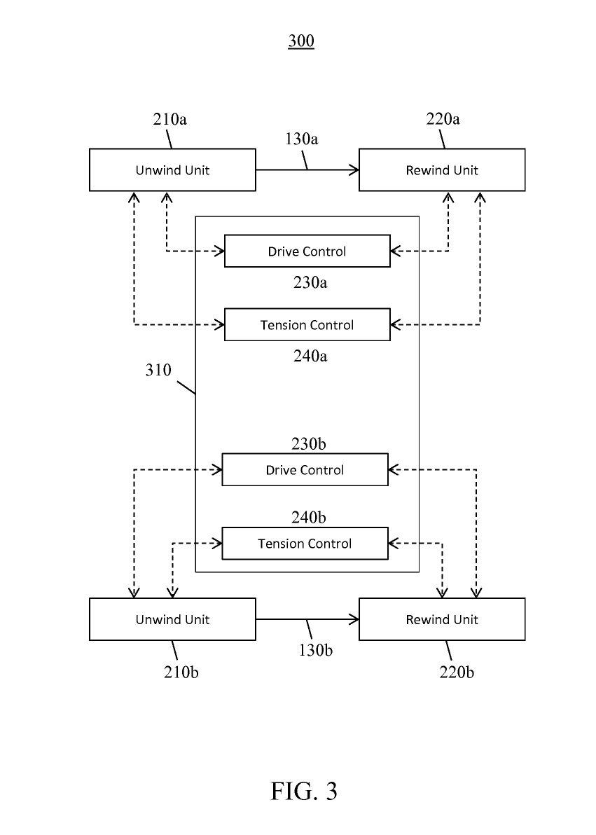

FIG. 3 shows a block diagram of a dual web conveyance system 300 in accordance with one or more embodiments of the present invention. Dual web conveyance system 300 may include a first unwind unit 210a configured to unspool a first web 130a from a first removable spool (not independently illustrated) and convey the first web 130a through a bath, such as an electroless plating bath, immersion plating bath, or other wet process bath (e.g., bath 110 of FIG. 1). A first rewind unit 220a may be configured to spool the first web 130a around a second removable spool (not independently illustrated) as it exits the bath. Similarly, a second unwind unit 210b may be configured to unspool a second web 130b from a third removable spool (not independently illustrated) and convey the second web 130b through the bath at the same time as the first web 130a. A second rewind unit 220b may be configured to spool the second web 130b around a fourth removable spool (not independently illustrated) as it exits the bath.

A control system 310 may include a first drive control unit 230a configured to control a first unspooling speed of the first unwind unit 210a and a first tension control unit 240a configured to control a first spooling tension of the first rewind unit 220a. The control system 310 controls the first unspooling speed of the first unwind unit 210a and the first spooling tension of the first rewind unit 220a to convey the first web 130a through the bath at a first predetermined speed and at a first predetermined tension. The first drive control unit 230a may independently control the rotational drive speed of the first unwind unit 210a and the first rewind unit 220a. The first tension control unit 240a may sense tension in the first web 130a and the control system 310 may adjust the rotational drive speed of one or more of the first unwind unit 210a and the first rewind unit 220a to achieve the first predetermined speed and the first predetermined tension.

The control system 310 also may include a second drive control unit 230b configured to control a second unspooling speed of the second unwind unit 210b and a second tension control unit 240b configured to control a second spooling tension of the second rewind unit 220b. The control system 310 controls the second unspooling speed of the second unwind unit 210b and the second spooling tension of the second rewind unit 220b to convey the second web 130b through the bath at a second predetermined speed and at a second predetermined tension. The second drive control unit 230b may independently control the rotational drive speed of the second unwind unit 210b and the second rewind unit 220b. The second tension control unit 240b may sense tension in the second web 130b and the control system 310 may adjust the rotational drive speed of one or more of the second unwind unit 210b and the second rewind unit 220b to achieve the second predetermined speed and the second predetermined tension.

The control system 310 may also be used to synchronize the speed and the tension of the webs 130a, 130b or run the webs 130a, 130b at their own application specific speeds and/or tensions. In certain embodiments, the first predetermined speed and the second predetermined speed may be synchronized to be the same. In other embodiments, the first predetermined speed and the second predetermined speed may be different. Similarly, in certain embodiments, the first predetermined tension and the second predetermined tension may be synchronized to be the same. In other embodiments, the first predetermined tension and the second predetermined tension may be different.

In certain embodiments, the first predetermined speed may be in a range between approximately 1 inch per minute and approximately 120 inches per minute. In other embodiments, the first predetermined speed may be in a range between approximately 120 inches per minute and approximately 240 inches per minute. Similarly, in certain embodiments, the second predetermined speed may be in a range between approximately 1 inch per minute and approximately 120 inches per minute. In other embodiments, the second predetermined speed may be in a range between approximately 120 inches per minute and approximately 240 inches per minute.

In certain embodiments, the first predetermined tension may be in a range between approximately 0.1 pounds per linear inch and approximately 6 pounds per linear inch. In other embodiments, the first predetermined tension may be in a range between approximately 6 pounds per linear inch and approximately 12 pounds per linear inch. Similarly, in certain embodiments, the second predetermined tension may be in a range between approximately 0.1 pounds per linear inch and approximately 6 pounds per linear inch. In other embodiments, the second predetermined tension may be in a range between approximately 6 pounds per linear inch and approximately 12 pounds per linear inch.

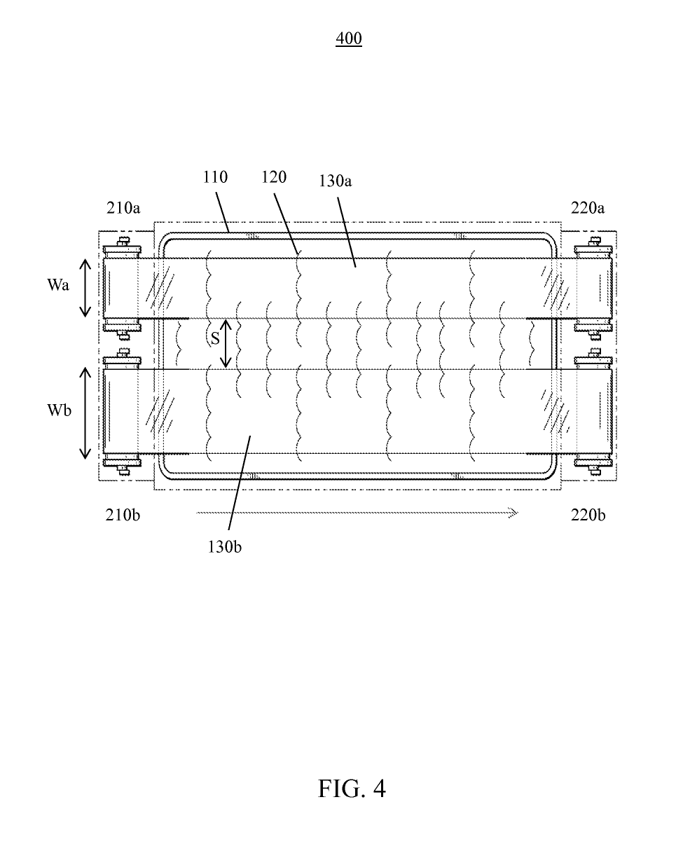

FIG. 4 shows a top down view of an electroless plating system 400 with dual web conveyance (e.g., dual web conveyance system 300) in accordance with one or more embodiments of the present invention. One of ordinary skill in the art will recognize that the dual web conveyance system could be used with other wet process systems in a similar manner in accordance with one or more embodiments of the present invention. The dual web conveyance system may be used to convey a first web 130a and a second web 130b through an electroless plating bath 110. The first unwind unit 210a and the second unwind unit 210b may be disposed on a first end of the electroless plating bath 110 to unwind and feed the first web 130a and the second web 130b that are conveyed through the electroless plating bath 110. The first rewind unit 220a and the second rewind unit 220b may be disposed on an opposing second end of the electroless plating bath 110 to receive and rewind the first web 130a and the second web 130b as they exit the bath. The first web 130a may be conveyed at a first predetermined speed and at a first predetermined tension. The second web 130b may be conveyed at a second predetermined speed and at a second predetermined tension.

In certain embodiments, the first web 130a and the second web 130b may be configured to be conveyed in a side-by-side orientation. In a side-to-side orientation, as opposed to an over-under orientation, neither web material becomes a barrier to the diffusion of gases or chemicals, promoting uniformity in the chemical environment that each web material is exposed to. In certain embodiments, the first web 130a and the second web 130b may be configured to be conveyed in a side-by-side orientation with minimal space between the first web 130a and the second web 130b. In other embodiments, the first web 130a and the second web 130b may be configured to be conveyed in a side-by-side orientation with a predetermined space, S, between the first web 130a and the second web 130b.

The dual web conveyance system may be configured to convey webs 130a, 130b having the same or different widths. The first web 130a may have a web width, Wₐ, and the second web 130b may have a web width, W_{b}. In certain embodiments, the first web 130a and the second web 130b may have the same width (Wₐ=W_{b}). In other embodiments, the first web 130a and the second web 130b may have different widths (Wₐ≠W_{b}). In the embodiment depicted in the figure, the second web 130b has a larger width than the first web 130a (W_{b}>Wₐ). In operation, the widths of the webs 130a, 130b may vary based on an application or design. For example, in certain touch sensor applications, widths of 14 inches and 17 inches may be common. As such, each of the first material 130a and the second material 130b may have a width of 14 inches or 17 inches and be conveyed through a commercially available electroless plating bath 110 at the same time at their own application-specific speeds and tensions.

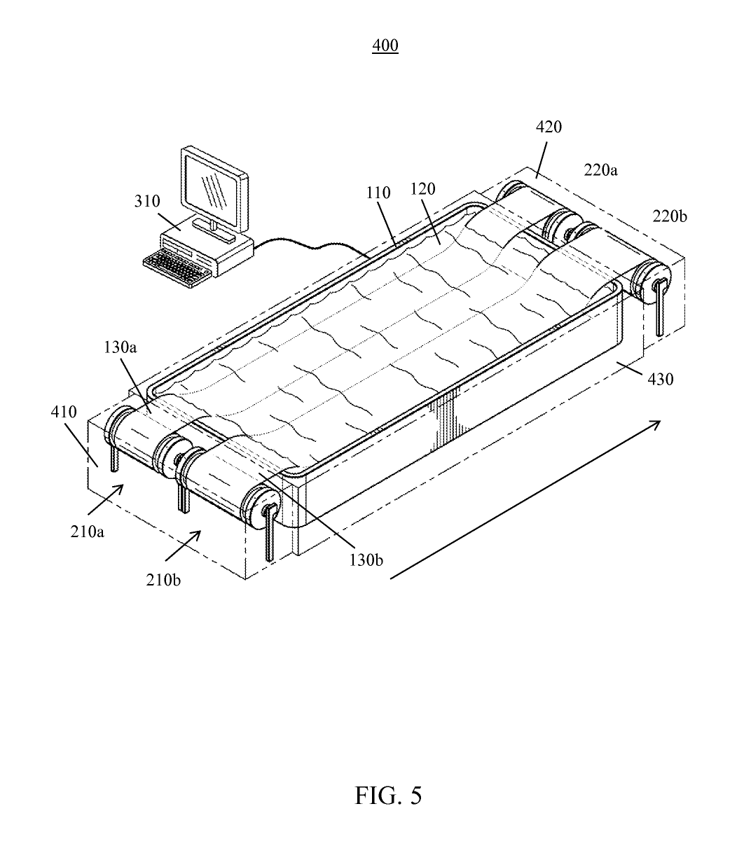

FIG. 5 shows a perspective view of an electroless plating system 400 with dual web conveyance (e.g., dual web conveyance system 300) in accordance with one or more embodiments of the present invention. In certain embodiments, a control system 310 may include a computer with a human-computer interface that allows an operator of the dual web conveyance system to input a first predetermined speed and a first predetermined tension for the first web 130a and a second predetermined speed and a second predetermined tension for the second web 130b. In certain embodiments, a removable cover 410 may be used to protect the first unwind unit 210a and the second unwind unit 210b from particulate matter and maintain clean room or near clean room conditions. Similarly, a removable cover 420 may be used to protect the first rewind unit 220a and the second rewind unit 220b. A removable bath cover 430 may be used to cover the bath during operation to provide protection from particulate matter, control diffusion, and potentially trap blanketing gases.

Advantages of one or more embodiments of the present invention may include one or more of the following:

In one or more embodiments of the present invention, a dual web conveyance system allows for the conveyance of a plurality of webs through the same wet process system concurrently using existing commercially available baths, providing increased capacity and throughput.

In one or more embodiments of the present invention, a dual web conveyance system allows for the conveyance of a plurality of webs where each web may be conveyed at a predetermined speed and at a predetermined tension that may vary based on an application or design.

In one or more embodiments of the present invention, a dual web conveyance system allows for the conveyance of a plurality of webs where each web may be conveyed at the same predetermined speed and tension or may vary from web to web.

In one or more embodiments of the present invention, a dual web conveyance system increases capacity, throughput, and efficiency.

In one or more embodiments of the present invention, a dual web conveyance system is configurable for a given application or design.

In one or more embodiments of the present invention, a dual web conveyance system is scalable for a desired capacity and/or throughput.

In one or more embodiments of the present invention, a dual web conveyance system is compatible with existing electroless plating baths and systems.

In one or more embodiments of the present invention, a dual web conveyance system is compatible with existing immersion baths and systems.

In one or more embodiments of the present invention, a dual web conveyance system is compatible with other wet process baths and systems.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A dual web conveyance system comprising:
a first unwind unit configured to unspool a first web from a first spool;
a first rewind unit configured to spool the first web around a second spool;
a second unwind unit configured to unspool a second web from a third spool;
a second rewind unit configured to spool the second web around a fourth spool;
a control system comprising:
a first drive control unit configured to control a first unspooling speed of the first unwind unit,
a first tension control unit configured to control a first spooling tension of the first rewind unit,
a second drive control unit configured to control a second unspooling speed of the second unwind unit, and
a second tension control unit configured to control a second spooling tension of the second rewind unit,
wherein the control system controls the first unspooling speed of the first unwind unit and the first spooling tension of the first rewind unit to convey the first web at a first predetermined speed and at a first predetermined tension, and
wherein the control system controls the second unspooling speed of the second unwind unit and the second spooling tension of the second rewind unit to convey the second web at a second predetermined speed and at a second predetermined tension.

2. The dual web conveyance system of claim 1, wherein the first predetermined speed is in a range between approximately 1 inch per minute and approximately 120 inches per minute.

3. The dual web conveyance system of claim 1, wherein the first predetermined speed is in a range between approximately 120 inches per minute and approximately 240 inches per minute.

4. The dual web conveyance system of claim 1, wherein the second predetermined speed is in a range between approximately 1 inch per minute and approximately 120 inches per minute.

5. The dual web conveyance system of claim 1, wherein the second predetermined speed is in a range between approximately 120 inches per minute and approximately 240 inches per minute.

6. The dual web conveyance system of claim 1, wherein the first predetermined speed and the second predetermined speed are synchronized.

7. The dual web conveyance system of claim 1, wherein the first predetermined speed and the second predetermined speed are different.

8. The dual web conveyance system of claim 1, wherein the first predetermined tension is in a range between approximately 0.1 pounds per linear inch and approximately 6 pounds per linear inch.

9. The dual web conveyance system of claim 1, wherein the first predetermined tension is in a range between approximately 6 pounds per linear inch and approximately 12 pounds per linear inch.

10. The dual web conveyance system of claim 1, wherein the second predetermined tension is in a range between approximately 0.1 pounds per linear inch and approximately 6 pounds per linear inch.

11. The dual web conveyance system of claim 1, wherein the second predetermined tension is in a range between approximately 6 pounds per linear inch and approximately 12 pounds per linear inch.

12. The dual web conveyance system of claim 1, wherein the first predetermined tension and the second predetermined tension are synchronized.

13. The dual web conveyance system of claim 1, wherein the first predetermined tension and the second predetermined tension are different.

14. The dual web conveyance system of claim 1, wherein the first web and the second web have a same width.

15. The dual web conveyance system of claim 1, wherein the first web and the second web have different widths.

16. The dual web conveyance system of claim 1, wherein the first web and the second web are configured to be conveyed in a side-by-side orientation with minimal space between the first web and the second web.

17. The dual web conveyance system of claim 1, wherein the first web and the second web are configured to be conveyed in a side-by-side orientation with space between the first web and the second web.

18. The dual web conveyance system of claim 1, wherein the first web and the second web comprise polyethylene terephthalate.

19. The dual web conveyance system of claim 1, wherein the dual web conveyance system is configured to convey the first web and the second web through an electroless plating bath.

20. The dual web conveyance system of claim 19, wherein the first unwind unit and the second unwind unit are disposed on a first end of the electroless plating bath and the first rewind unit and the second rewind unit are disposed on an opposing second end of the electroless plating bath.
